(19) United States
(12) Patent Application Publication
(10) Pub. No.: US 2007/0046939 A1
(43) Pub. Date: Mar. 1, 2007

(54) Methods and systems for positioning sample containing assemblies in an optical device

(76) Inventors: George P. Tsai, San Jose, CA (US); John C. Kralik, Devon, PA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/209,520

(22) Filed: Aug. 23, 2005

(51) Int. Cl. G01B 11/00

(52) U.S. Cl. 356/399

(57) ABSTRACT

Method and system for positioning an assembly in an optical device.

### BACKGROUND OF THE INVENTION

There are many user environments, the fields of medical research and pharmaceutical development being examples, where it is necessary to accurately acquire fluid samples and where also often desirable to measure optical characteristics of the acquired fluid samples. Such optical characteristics include, for example, the ability of a sample to absorb light. The acquired samples have volumes that may be as small as a few nanoliters. In the measurement of optical characteristics, and especially when the samples have small volumes, it is highly desirable, and sometimes necessary, that the largest measurement amplitude be obtained. In many instances, the largest measurement amplitude is obtained when the sample is centered with respect to the optical path of the beam of electromagnetic radiation provided by the optical instrument. For instance, when the optical instrument is a spectrophotometer, the integrated signal value is substantially maximized when the sample is centered in the spectrophotometer's optical path.

There is a need for methods and systems that automatically position the sample in the optical path of an optical measuring system in order to maximize the measurement amplitude.

### SUMMARY OF THE INVENTION

One embodiment of the method of this invention for positioning an assembly in an optical device includes the steps of positioning the assembly off center with respect to an optical path of a beam of electromagnetic radiation provided by the optical device, measuring an optical property utilizing the optical device, and translating the assembly, in a direction substantially transverse to the optical path, to another position. The steps of measuring the optical property and of translating the assembly are repeated until a desired position is determined, where a substantial maximum of the measured optical property is obtained at the desired position. The assembly is then positioned substantially at the desired position.

One embodiment of the system of this invention includes a vessel holding element capable of holding a vessel in a predetermined position with respect to a beam of electromagnetic radiation, and optical subsystem capable of providing the beam of electromagnetic radiation, a positioning subsystem capable of repeatably positioning the vessel holding element, where the vessel holding element is positioned in a direction transverse to the beam of electromagnetic radiation, and a component capable of determining a position at which a substantial maximum of the measured optical property can be obtained.

In one embodiment, the component capable of determining the position at which the vessel is substantially centered includes one or more processors and one of more computer usable media. The computer usable media has computer readable code embodied therein, where the computer readable code is capable of causing the one or more processors to execute an embodiment of the method of this invention.

### BRIEF DESCRIPTION OF THE DRAWINGS

For a better understanding of the present invention, reference is made to the accompanying drawings and detailed description and its scope will be pointed out in the appended claims.

FIG. 1 is a schematic block diagram representation of an embodiment of the method of this invention;

FIG. 2 is a schematic block diagram representation of another embodiment of the method of this invention;

FIG. 3 is a schematic block diagram representation of one embodiment of the system of this invention;

FIG. 4 is a schematic block diagram representation of a component of an embodiment of the system of this invention;

FIG. 5 is a schematic graphical representation of another component of an embodiment of the system of this invention;

FIG. 6 is a schematic graphical representation of yet another component of an embodiment of the system of this invention;

FIG. 7 is a schematic graphical representation of still another component of an embodiment of the system of this invention;

FIG. 8 is a schematic graphical representation of another embodiment of the system of this invention; and

FIG. 9 is a schematic graphical representation of results of an embodiment of the method of this invention.

### DETAILED DESCRIPTION OF THE INVENTION

Before describing the present invention in detail, it is to be understood that this invention is not limited to specific apparatuses, method steps, or equipment, as such may vary. It is also to be understood that the terminology used herein is for the purpose of describing particular embodiments only, and is not intended to be limiting. Methods described herein may be carried out in any order of the recited steps that is logically possible. Furthermore, where a range of values is provided, it is understood that every intervening value, between the upper and lower limit of that range and any other stated or intervening value in that stated range is encompassed within the invention. Also, it is contemplated that any optional feature of the inventive embodiments and aspects described herein may be set forth and claimed independently, or in combination with any one or more of the features described herein, or may be specifically excluded.

Unless defined otherwise below, all technical and scientific terms used herein have the same meaning as commonly understood by one of ordinary skill in the art to which this invention belongs. Still, certain terms are defined herein for the sake of clarity.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed. All publications mentioned herein are incorporated herein by reference to disclose and describe the methods and/or materials in connection with which the publications are cited.

It must be noted that, as used in this specification and the appended claims, the singular forms “a”, “an” and “the” include plural referents unless the context clearly dictates otherwise. Thus, for example, reference to “a biopolymer” includes more than one biopolymer, and the like.

It will also be appreciated that throughout the present application, that words such as “upper”, “lower” are used in a relative sense only.

The term “assessing” and “evaluating” are used interchangeably to refer to any form of measurement, and includes determining if an element is present or not. The terms “determining,” “measuring,” and “assessing,” and “assaying” are used interchangeably and include both quantitative and qualitative determinations. Assessing may be relative or absolute. “Assessing the presence of” includes determining the amount of something present, as well as determining whether it is present or absent.

The term “using” has its conventional meaning, and, as such, means employing, e.g. putting into service, a method or composition to attain an end.

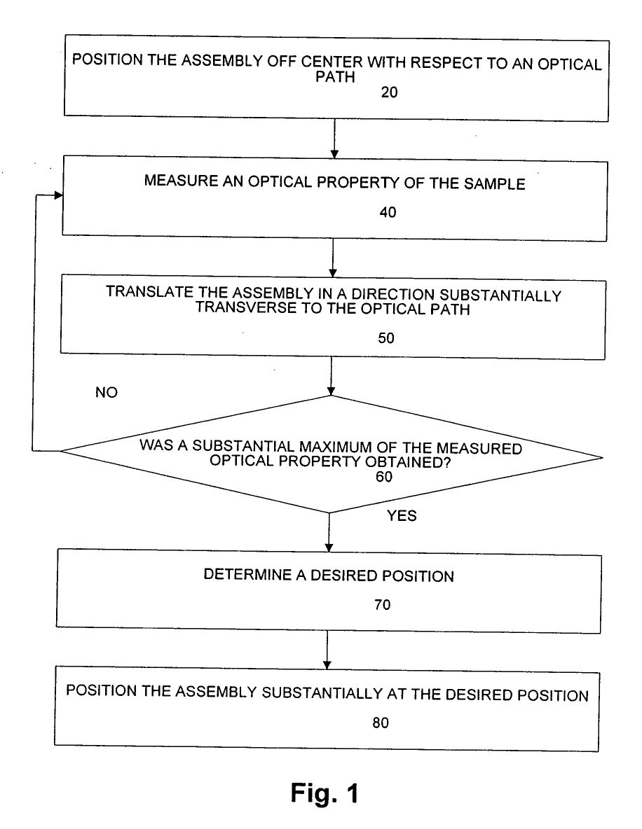

An embodiment 10 of the method of this invention for positioning an assembly in an optical device, where the assembly includes a sample, is shown in FIG. 1. Referring to FIG. 1, the embodiment 10 of the method of this invention includes the steps of positioning the assembly off center with respect to an optical path of a beam of electromagnetic radiation provided by the optical device (step 20, FIG. 1), measuring an optical property of the sample utilizing the optical device (step 40, FIG. 1), and translating the assembly, in a direction substantially transverse to the optical path, to another position (step 50, FIG. 1). A determination is then made as to whether a relative maximum has been approximately obtained (a substantially maximum value, a relative maximum being a local maximum instead of a global maximum) in the measurement performed, in previous measurements or a maximum lies between two measurements (step 60, FIG. 1). If a maximum has not been approximately obtained, steps 40 and 50 are repeated until a relative maximum has been approximately obtained and. If a relative maximum has been approximately obtained or a maximum appears to lie between two measurements, a position is determined at which the relative maximum is substantially obtained (step 70, FIG. 1). The assembly is then positioned substantially at the determined position (step 80, FIG. 1).

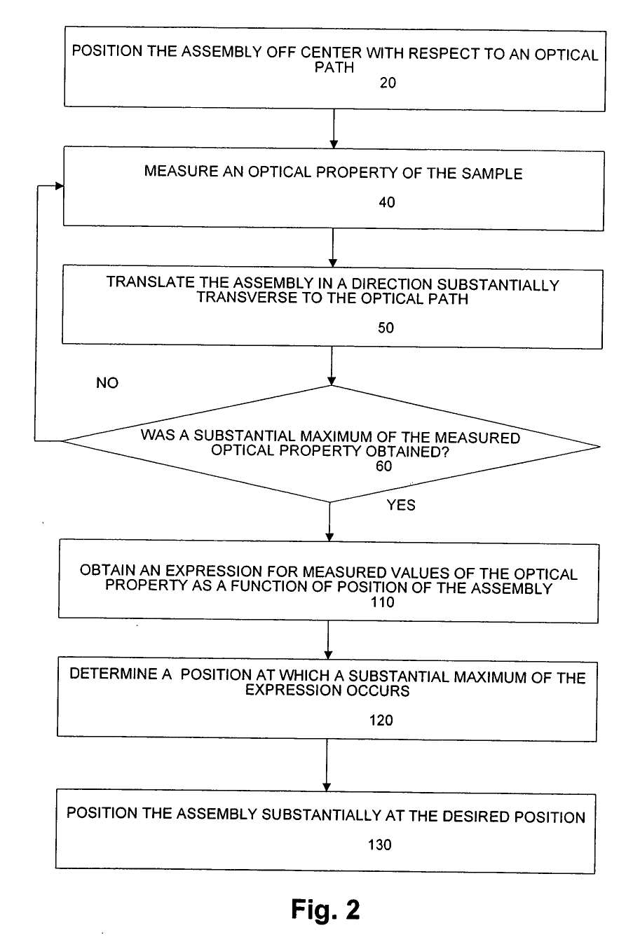

Another embodiment 100 of the method of this invention is shown in FIG. 2. (Steps common to both embodiments retain the same numbering as in FIG. 1.) Referring to FIG. 2, the embodiment 100 of the method of this invention includes the steps of positioning the assembly off center with respect to an optical path of a beam of electromagnetic radiation provided by the optical device (step 20, FIG. 2), measuring an optical property of the sample utilizing the optical device (step 40, FIG. 2), and translating the assembly, in a direction substantially transverse to the optical path, to another position (step 50, FIG. 2). A determination is then made as to whether a maximum has been approximately obtained (a substantially relative maximum value) in the measurement performed, in previous measurements or a maximum lies between two measurements (step 60, FIG. 2). If a maximum has not been approximately obtained, steps 40 and 50 are repeated until a relative maximum has been approximately obtained and. If a relative maximum has been approximately obtained or a maximum appears to lie between two measurements, an expression is obtained approximately describing the measured values of the optical property as a function of the position of the assembly (step 110, FIG. 2). The position at which a substantial maximum of the expression is approximately (substantially) obtained is also determined (step 120, FIG. 2). The assembly is then positioned substantially at the determined position (step 130, FIG. 2).

It should be noted that, in one embodiment, this invention not being limited only to this embodiment, a determination as to whether a relative maximum has been approximately obtained or a relative maximum appears to lie between two measurements can be made by comparing subsequent measurements and the determining whether the rate of change of the measured values and goals from increasing (positive) to decreasing (negative), or vice versa.

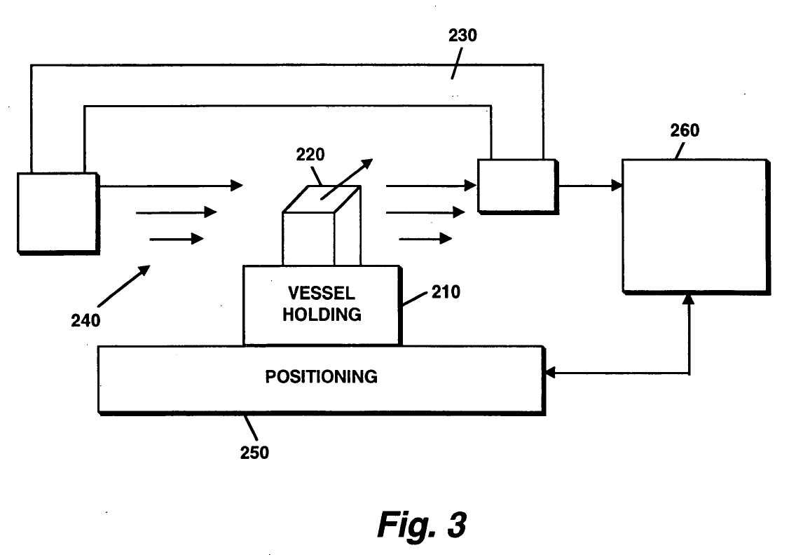

An embodiment 200 of the system of this invention is shown in FIG. 3. Referring to FIG. 3, the embodiment 200 of the system of this invention includes a vessel holding element 210, the vessel holding element 210 being capable of holding a vessel 220, where the vessel contains a sample (not shown). The vessel holding element 210 holds the vessel in a determined position with respect to a beam of electromagnetic radiation 240. An optical subsystem 230 provides the beam 240 of electromagnetic radiation and is also capable of performing an optical measurement of an optical property of the sample. A positioning subsystem 250 is capable of substantially repeatably positioning the vessel holding element 210 in a direction substantially transverse to the optical path of the beam 240 of electromagnetic radiation. An analysis component 260 is capable of determining a position at which a substantially relative maximum value of the optical measurement is obtained.

In one embodiment, but not limited only to this embodiment, the vessel 220 is a cuvette, a micro cuvette, a pipette, or a micro pipette. The vessel holding element 210 may be, but is not limited to, a housing holding the vessel or an element of specific design and that enables the holding of the vessel. The positioning subsystem 250 can be, but is not limited to, a stepper motor with a lead screw and means for operatively connecting the vessel holding element 210 to the lead screw (such as a nut or a slide), a linear motor, a motor and encoder system and a slide, carriage or nut, or a similar motion producing subsystem (structure) that is substantially repeatable in its positioning characteristics and means for operatively connecting the vessel holding element 210 to the motion producing structure in the positioning subsystem 250 (such a structure to attach to). The optical subsystem 230 can be, but is not limited to, a portion of (or the entire) a measurement system such as, for example, a spectrophotometer. The analysis component 260 can be, but it are limited to, a component including digital or analog electronics (or mechanical analogues) that enables the determination of the position at which a substantially relative maximum value is obtained for the measured optical property of the sample contained in the vessel 220 or at which the vessel 220 is substantially centered with respect to the beam of electromagnetic radiation. The analysis component 260 is operatively connected to the optical subsystem 230 and to the positioning subsystem 250. In one embodiment, the analysis component 260 receives measurement data for the measured optical property from the optical subsystem and receives/provides positioning data from/to the positioning subsystem 250.

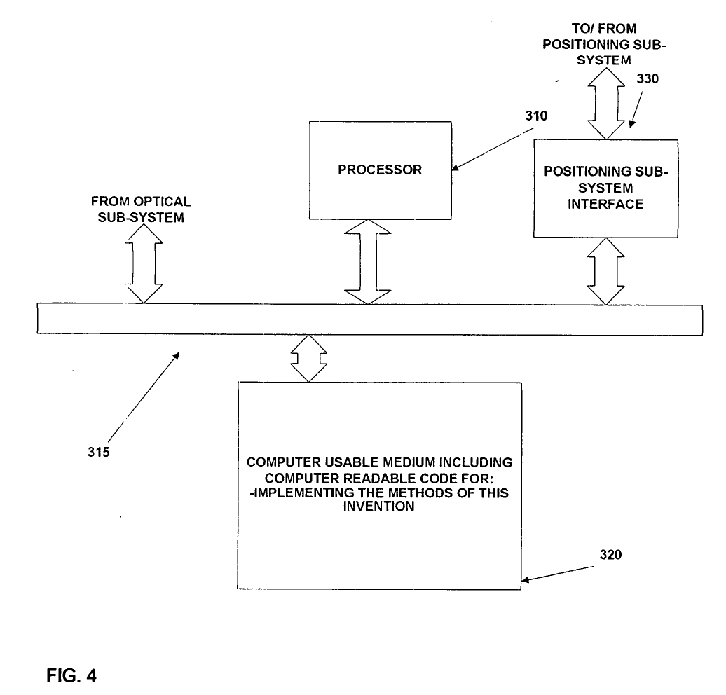

One embodiment 300 of the analysis component 260 is shown in FIG. 4. Referring to FIG. 4, the embodiment 300 of the analysis component 260 shown in FIG. 4 includes one or more processors 310 and one on more computer usable media having computer readable code embodied therein. The embodiment 300 shown in FIG. 4 is capable of receiving measurement data from the optical subsystem 230 and of receiving/sending positioning data to/from the positioning subsystem 250. The computer readable code is capable of causing the one or more processors to provide a positioning command to the positioning subsystem 250 and to determine a position at which the vessel is substantially centered with respect to the beam of electromagnetic radiation. In one embodiment, the positioning command can cause the positioning system 252 to position (change/institute a position) the vessel holding element 210.

In one instance, the computer readable code, in causing their one or more processors 310 to determine the position at which the vessel is substantially center, cause is the one or more processors to determine a position at which an approximate (also referred to as substantially) relative maximum of the optical property is obtained. In one embodiment, the position at which an approximate relative maximum of the optical property is obtained is determined by obtaining an expression for the measured values of the optical property, obtaining an approximate relative maximum of the expression and determining the position at which the approximate relative maximum of the expression is obtained.

The embodiment 300 of the analysis component 260 shown in FIG. 4 also includes an interface component 330 capable of receiving a positioning command from the one or more processors and/or of providing a positioning signal to the positioning subsystem 250. It should be noted that, in the embodiment in which the positioning system 250 is configured such that it can accept signals directly from the embodiment 300 of the analysis component 260, the interface component 330 may not be necessary. The one or more processors 310, the one or more computer usable media 320 and the interface component 330 are operatively connected by means of a connection component 315 (the connection component may be, for example, a computer bus, or a carrier wave).

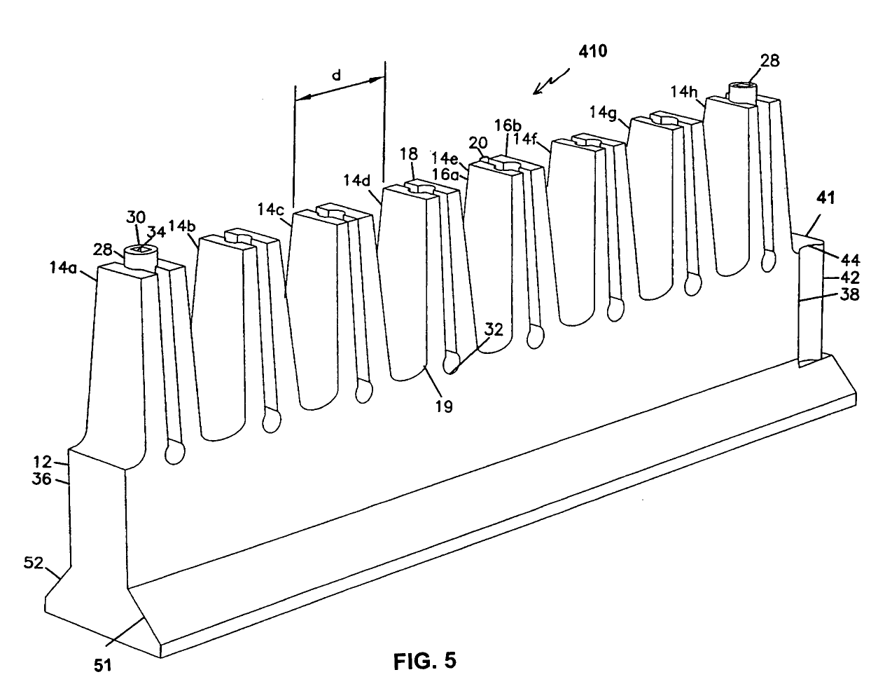

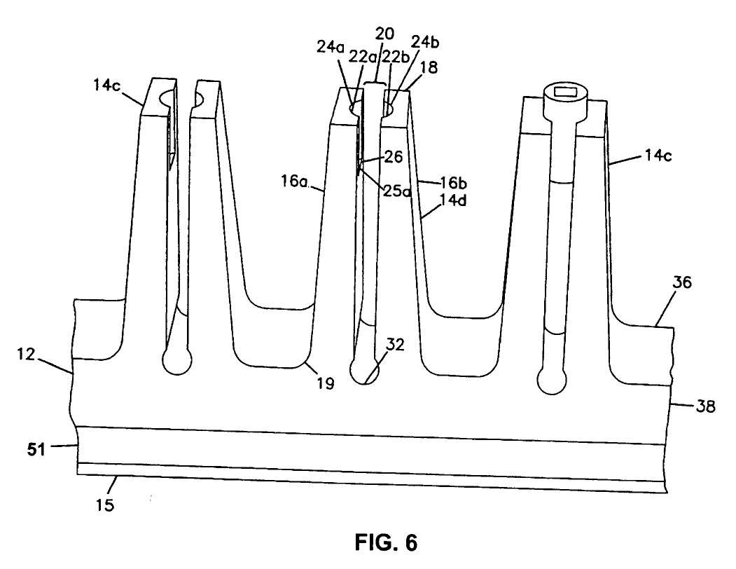

Embodiments of the vessel holding element 210, this invention not being limited to only these embodiments, are shown in FIGS. 5 and 6. Referring to FIGS. 5 and 6, one possible embodiment of a vessel holding element 410 that provides a fixture for holding vessels includes an elongated support member 12, eight vessel holders or brackets 14a-14h, and a base 15. The elongated support member 12 has oppositely disposed sides 36 and 38 extending along its length, and has an end portion 41. The brackets 14a-14h are operatively connected to (e.g., either directly or indirectly linked to) and are structured to hold a capillary vessel such as a Cuvette 28 (shown mounted in brackets 14a and 14h in FIG. 5 and in bracket 14c in FIG. 6). Although the exemplary embodiment illustrates Cuvettes 28, other embodiments of the vessel holding element 410 are configured to hold vessels other than Cuvettes 28.

Bracket 14d has a top edge 18, a bottom portion 19 attached to the elongated support member 12, and two opposing and elongated bracket members 16a and 16b such as fingers, tines, or prongs. The two opposing bracket members 16a and 16b are separated by a gap 20, which provides an aperture for an optical path when the common carrier 10 is used with a spectrophotometer or similar instrument so that light can pass through the Cuvette 28. The width of the gap 20 can vary between embodiments to match the distance between the reservoirs (for example, but not limited to, wells in a microtiter plate) from which samples are loaded.

Bracket member 16a has a recess 22a formed by a concave surface 24a and a radial surface 25a. The recess 22a opens to the top edge 18 of the bracket 14d and extends toward the bottom portion 19 to the radial surface 25a. The concave surface 24a and the radial surface 25a are substantially orthogonal. Bracket member 14b has a recess 22b substantially similar to and opposing the recess 22a. The recess 22b is formed by a concave surface 24b and a radial surface (not shown). In one possible embodiment, as explained in more detail herein, the shape of the recesses 22a and 22b conform to the outer circumference of the vessel, which in the exemplary embodiment is a Cuvette 28 (shown mounted in brackets 14a and 14h).

The recesses 22a and 22 b form a receptacle for holding the Cuvette 28. Additionally, the radial surface 25a of the elongated bracket member 16a and the radial surface (not shown) of the elongated bracket member 16b form a seat 26 against which the Cuvette 28 is positioned. Additionally, the distance between the seat 26 and the top edge 18 of the bracket 16d is smaller than the height of the Cuvette 28 so that when the Cuvette 28 is positioned against the seat 26, the top edge 30 of the Cuvette 28 extends at least slightly beyond the top edge 18 of the bracket 14d, which assists capillary uptake of the sample. Additionally, the distances from the elongated support member 12 to the seat 26 and from the top edge 18 to the seat 26 are substantially consistent between each of the brackets 14a-14h.

The bottom portion 19 of the bracket 14d defines a break 32 that is open to the gap 20 and extends between the sides 36 and 38 of the elongated support member 12 and has a circular cross-section with a circumference slightly larger than the width of the gap 20. The break provides a relief that makes it easier to spread the bracket members 16a and 16b so that a Cuvette 28 can be mounted in the recesses 22a and 228. An alternative embodiment does not includes the break 32, which makes the common carrier easier to mold when it is formed with a plastic, acrylic, or similar material. In this alternative embodiment the gap 20 terminates at the base portion of the bracket 14d. In another alternative embodiment, the gap 20, with out without a break 32 terminates at a midpoint between the top edge 30 and the bottom portion 19 of the bracket 14d.

The vessel holding element 410 is formed with a resilient material so that the bracket members 16a and 16b of the bracket 14d can be spread and will naturally return to their original position. In this embodiment, the elongated bracket members 16a and 16b exert a spring force against the side of the Cuvette 28 and hold it in the receptacle formed by the recesses 22a and 22b. In one possible embodiment, the common carrier is a single piece and that is injection molded and formed with polycarbonate, acrylic, polysulphone, or another medical grade material that is resilient.

Brackets 14a-14c and 14e-14h are substantially similar to the bracket 14h. In one possible embodiment, the distance “d” between adjacent brackets 14 is about 9 mm, which corresponds to a typical distance between wells in the column of a microtiter plate. In other possible embodiments, the distance “d” is a distance other then 9 mm and matches the distance between adjacent reservoirs from which samples are loaded into the Cuvettes 28.

In one exemplary embodiment, the Cuvette 28 has an internal cavity 24 with a depth of about 4 mm and cross-sectional dimensions of about 1 mm and about 1 mm to form a capacity volume of about 4 μl. Other embodiments use cuvettes of different sizes. Although a cuvette of a particular size and structure is illustrated, other embodiments of the common carrier 10 can be used and configured for vessels (including Cuvettes in the instance shown in FIGS. 5 and 6) of other sizes and for other types of vessels. For example, an alternative embodiment of a Cuvette has internal dimensions, of about 2 mm by about 1 mm by about 1 mm to form a capacity volume of about 2 μl.

When the vessel holding element is used with a spectrophotometer, one possible embodiment of the Cuvette 28 or other vessel has internal dimensions sized to be about the same size as or only slightly larger than the cross-sectional area of the light beam passed through the Cuvette 28. Any sample loaded in the Cuvette that is not in the path of the light-beam is not analyzed by the spectrophotometer.

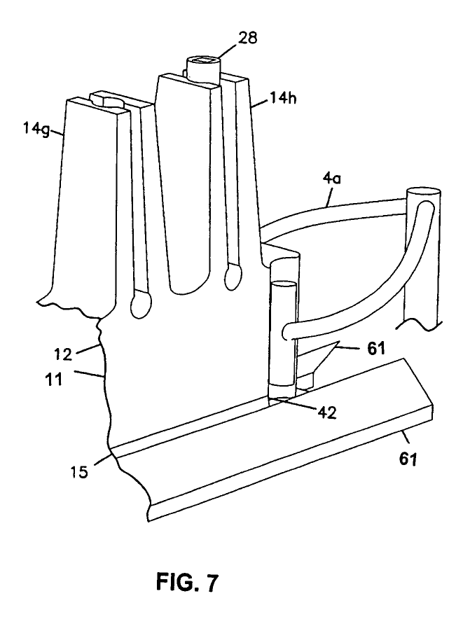

One embodiment of the means for operatively connecting the vessel holding element 410 to the positioning subsystem 250 is shown in FIG. 7. Referring to FIG. 7, the end 41 of the elongated support member 12 has a grip 42, which is formed with a first grip groove 44 defined in the first side 36 of the elongated support member 12. The first grip groove 44 is linear and extends from and is orthogonal to the base 15. A second grip recess (not shown) that mirrors the first recess 44 is formed on the opposite side 38 of the elongated support member 12. The grip 42 provides a structure by which a clamping mechanism 46 for an automated spectrometer can grip or latch onto the vessel holding element 410 while the vessel holding element 410 is indexed through an a spectrophotometer or other analytical instrument for testing samples loaded in the cuvettes 28. The structure of the grip 42 can vary depending on the clamping mechanism 46 that grips or latches onto the vessel holding element 410. It should be noted that other means for operatively connecting the vessel holding element 210 are also within the scope of this invention. For example, but not only limited to these examples, if the vessel holding element 210 comprises a housing, the housing can be adapted to be attached by either pressure or a physical connection (such as the use of pins or bolts or the use of spring loaded mechanisms).

Referring back to FIGS. 5 and 6, in one possible embodiment, the base 15 extends along the bottom portion of the elongated support member 12 and has a dovetail cross-section providing a width substantially wider than the elongated support member 12. Sidewalls 51 and 52 slope downward from the sides 36 and 38, respectively, of the elongated support member 12 to the bottom portion of the base 15. The base 15 provides a structure that stabilizes the common carrier 11 when it is set on a lab bench or tabletop.

In one possible embodiment, the base 15 is configured to be slidably inserted into a structure for operatively connecting the vessel holding element 410 to the positioning subsystem 250 that and retains the vessel holding element 410 in the automated spectrophotometer. In yet another possible embodiment, the base 15 includes indicia (not shown) indicating the location of each bracket on the vessel holding element 410. Each of the indicia is a distinctive machine-readable marking that provides a positioning guide to locate and orient the Cuvettes 28 in the automated spectrophotometer. Such indicia could be considered to be included in the positioning subsystem 250 or to be used by the positioning subsystem 250. The automated spectrophotometer indexes the vessel holding element 410 by translating the vessel holding element 410 to the correct position so that the cuvette 28 is at the desired position within the optical path of the automated spectrophotometer.

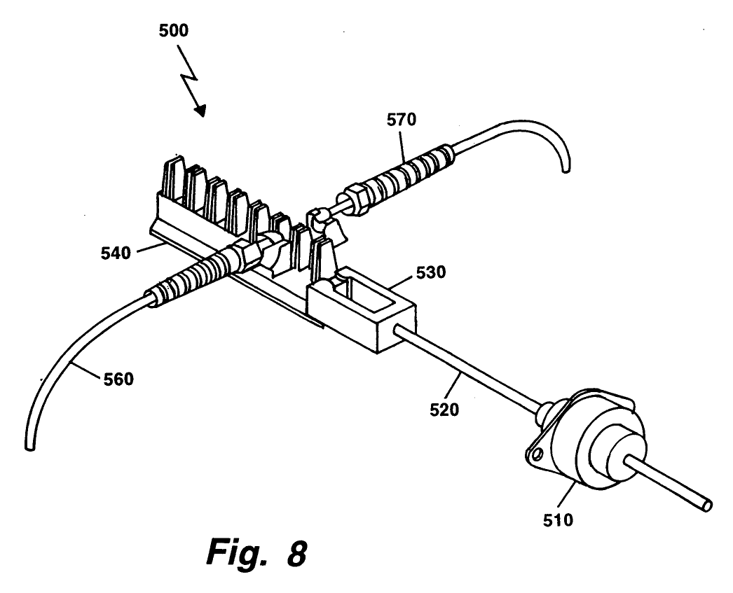

One exemplary embodiment 500 of the system of this invention is shown in FIG. 8. Referring to FIG. 8, the embodiment of the positioning subsystem 250 comprises a high-resolution stepper motor 510 attached to a lead screw 520 and a clamp 530. A vessel holding element 540 of similar design to the embodiments shown in FIGS. 5 and 6 and optical fibers 560 and 570 are components in the optical subsystem 230 in the embodiment 500 of the system of this invention. The high-resolution stepper motor 510 and the lead screw 520 are designed such that a position of the vessel holding element 540 can be substantially repeated for the same control inputs to the high-resolution stepper motor 510. The optical fibers 560 and 570 provide a beam of electromagnetic radiation. The portion of the optical subsystem 230 that provides the value of the measured optical property and the component 260 capable of determining the position at which the vessel is substantially centered with respect to the beam of electromagnetic radiation or at the position at which an approximate relative maximum of the measured optical property is obtained are not shown in FIG. 8.

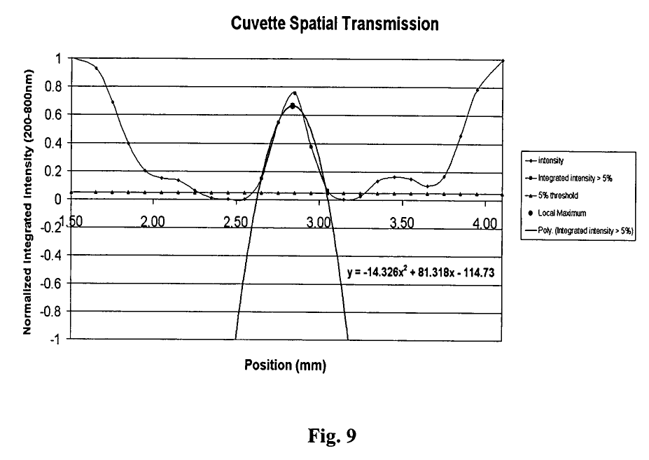

In order to better illustrate the method and system of this invention, results of an exemplary embodiment are presented herein below and shown in FIG. 9. Utilizing an embodiment of the system of this invention such as that shown in FIGS. 3 and 8, the vessel (assembly), in which the sample is contained, and which is held by the sample holding element 540 is positioned off center with respect to the beam of electromagnetic radiation provided by the optical fibers 560 and 570 (in one embodiment, the vessel is positioned close to but short of the desired position, centered with respect to the beam of electromagnetic radiation). The position of the vessel is incremented in small increments in the direction of increasing values of the measured optical property. At each increment, in the embodiment in which the optical system is a portion of a spectrophotometer, the integrated signal intensity is obtained and provided to the analysis component 260 capable of determining the position at which the vessel is substantially centered with respect to the beam of electromagnetic radiation. The position at each increment it also provided to the analysis component 260. In one embodiment, the small increments are selected to be approximately 10% of the vessels internal width. (In the embodiment in which the vessel is a cuvette of internal width of 1 mm, the increments are approximately 0.1 mm.) The existence of a local relative maximum is determined by the change in rate of change of the measured optical property (for example, the values of the measured optical property stop increasing and start to decrease). In one embodiment, the increments in position are obtained by control signals given to the stepper motor 510. Values of the measured optical property in the vicinity of the local relative maximum that are above a predetermined threshold are utilized to obtain a curve fit for the functional relationship between the position and the measured optical property (in the embodiment shown in FIG. 9, the functional relationship is a second order polynomial). The desired centered position of the vessel is approximately the position at which the second-order polynomial has a maximum. (For an embodiment of the curve fit, an algorithm that approximately finds a maximum is applied. For a second order polynomial, the maximum is located at the position at which the derivative of the second order polynomial is approximately zero.) The stepper motor 510 is provided with control signals that position the vessel holding element and the vessel at substantially the desired position. Exemplary results are shown in FIG. 9.

In general, the techniques described above may be implemented, for example, in hardware, software, firmware, or any combination thereof. The computer implementable techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program (code) within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable or usable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Although the invention has been described with respect to various embodiments, it should be realized this invention is also capable of a wide variety of further and other embodiments within the spirit and scope of the appended claims.

What is claimed is:

1. A method for positioning an assembly in an optical device, the assembly being capable of holding a sample, the method comprising the steps of:
a) positioning the assembly off center with respect to an optical path of a beam of electromagnetic radiation provided by the optical device;
b) measuring an optical property of the sample utilizing the optical device;
c) moving the assembly, in a direction substantially transverse to the optical path, to another position;
d) repeating steps b) and c) until a desired position is determined, a substantial maximum of the measured optical property being obtained substantially at the desired position; and
e)positioning the assembly substantially at the desired position.

2. The method of claim 1 wherein, in the desired position, the assembly is substantially centered with respect to the optical path at the desired position.

3. The method of claim 1 wherein the desired position is determined by the steps of:
obtaining an expression for measured values of the optical property as a function of position of the assembly; and
obtaining a substantial maximum of the expression; and
obtaining the desired position substantially at which the substantial maximum occurs.

4. A system for positioning a vessel in an optical device, the vessel being capable of holding a sample, the system comprising:
a vessel holding element capable of holding a vessel in a predetermined position with respect to a beam of electromagnetic radiation;
an optical subsystem capable of providing the beam of electromagnetic radiation;
a positioning subsystem capable of substantially repeatably positioning said vessel holding element in a direction substantially transverse to the optical path of the beam of electromagnetic radiation; and
a component capable of determining a position at which the vessel is substantially centered with respect to the beam of electromagnetic radiation.

5. The system of claim 4 wherein said optical subsystem is also capable of measuring an optical property; and
wherein said component, in determining said position, is capable of determining a substantially maximum value of the optical property and a position at which the substantial maximum occurs.

6. The system of claim 4 wherein said component comprises:
at least one processor: and
at least one computer usable medium having computer readable code embodied therein, said a computer readable code being capable of causing said at least one processor to:
provide a positioning command to said positioning subsystem, said positioning command capable of causing said positioning subsystem to alter/institute a position of said vessel holding element, and
determine a position at which the vessel is substantially centered with respect to the beam of electromagnetic radiation.

7. The system of claim 6 wherein said component further comprises:
a positioning subsystem interface subcomponent capable of receiving a positioning command from said at least one processor and providing a positioning signal to said positioning subsystem.

8. The system of claim 6 wherein said computer readable code in causing said at least one processor to determine a position at which the vessel is substantially centered further causes said at least one processor to:
determine a position at which a substantially maximum value of the measured optical property is obtained.

9. The system of claim 8 wherein said computer readable code in causing said at least one processor to determine a position at which the substantial maximum of the measured optical property is obtained further causes the processor to:
obtain an expression for measured values of the optical property; and
obtain a substantial maximum of the expression at a determined position.

10. The system of claim 4 wherein said vessel holding element comprises:
a support member; and
at least one vessel holder operatively connected to the support member.

11. The system of claim 10 wherein the vessel is a cuvette.

12. The system of claim 10 wherein said at least one vessel holder defines a seat for positioning the vessel.

13. The system of claim 10 wherein said at least one vessel holder includes first and second elongated members, the first and second elongated members defining a gap, the gap forming an aperture for passing electromagnetic radiation through the vessel.

14. The system of claim 13 wherein said at least one vessel holder includes a top edge and the gap extends from the support member to the top edge.

15. The system of claim 4 wherein said optical subsystem comprises a portion of a spectrophotometer.

16. A computer program product comprising a computer usable medium having computer readable code embodied there in, said computer readable code being capable of causing at least one processor to:
provide a positioning command to a positioning subsystem, said positioning command capable of causing said positioning subsystem to substantially repeatably position a vessel holding element, and determine a position at which a vessel held by the vessel holding element is substantially centered with respect to a beam of electromagnetic radiation.

17. The computer program product of claim 16 wherein said computer readable code in causing said at least one processor to determine a position at which the vessel is substantially centered further causes the processor to:
determine a position at which a substantially maximum value of a measured optical property is obtained.

18. The computer program product of claim 17 wherein said computer readable code in causing said at least one processor to determine a position at which the vessel is substantially centered further causes the processor to:
obtain an expression for measured values of the optical property; and
obtain a substantially maximum value of the expression at a determined position.
